(19) United States
(12) Patent Application Publication
(10) Pub. No.: US 2018/0242397 A1
(43) Pub. Date: Aug. 23, 2018

(54) Radio Communication Method and System

(71) Applicant: Woei-jia Hwang, Taichung City (TW)

(72) Inventor: Woei-jia Hwang, Taichung City (TW)

(21) Appl. No.: 15/752,297

(22) PCT Filed: Aug. 31, 2015
(86) PCT No.: PCT/CN2015/088580

§ 371 Date: Feb. 13, 2018

(51) Int. Cl. H04W 92/02; H04W 88/16; H04W 92/06; H04W 76/11

(52) U.S. Cl. CPC H04W 92/02; H04W 76/11; H04W 92/06; H04W 88/16

(57) ABSTRACT

Disclosed are a radio communication method and system. The system comprises at least one radio end, at least one transfer system and at least one external communication end, wherein the radio end is connected to the transfer system via a radio signal, the transfer system compares a radio dialling number in the radio signal with registration data stored by the transfer system, and the transfer system transfers the radio signal to a corresponding external communication end according to a comparison result. By means of a connection between a radio gateway in the transfer apparatus and the server, a remote radio end can communicate with a specific external communication end without the limitation of territory or distance.

### FIELD OF THE INVENTION

The present invention relates to a communication method, and more particularly to a communication method between radios and other network systems.

### BACKGROUND OF THE INVENTION

Existing radio communication systems operate in different frequency ranges such as very high frequency (VHF), ultra-high frequency (UHF), high frequency (HF) and the like, depending on laws and regulations of the country where the radio communication systems are operated in. While compared to other phones or mobile phones, the major feature of radiophones is that radiophones are capable of broadcasting signals within an acceptable range to other radiophones, so as to achieve two-way communications.

In general, radio transmission is often limited by terrain, transmission power and the like, so that the personnel at the radiophone end are limited to the places where broadcast signals can be reached. Therefore, limitations such as communication dead zone and area-specific availability of communication service are commonly encountered.

### SUMMARY OF THE INVENTION

To overcome shortcomings of conventional radio communications, the present invention provides a radio communication-end radio communication method that includes the following steps:

receiving a radio signal output from a radio end;

comparing a radio dialing number in the radio signal with a registration data, in which the registration data includes at least one external communication end code and at least one radio dialing number, and each of the radio dialing numbers corresponds to an external communication end code;

transferring the radio signal to a corresponding external communication end according to a comparison result of comparing the radio dialing number with the external communication end code; and

receiving an external communication signal input from the external communication end.

In which the radio dialing number is incorporated in the radio signal by utilizing dual-tone multi-frequency codes.

In which the radio signal includes an internal code.

In which the radio signal includes a satellite coordinate or an auxiliary signal.

The present invention further provides an external communication-end radio communication method which includes the following steps:

receiving an external communication signal having an external communication dialing number transmitted from at least one external communication end;

comparing the external communication dialing number of the external communication signal with an internally stored registration data, in which the registration data includes at least one external communication dialing number and at least one radio gateway code, and each of the at least one external communication dialing number corresponds to one of the at least one radio gateway code, and outputting a radio signal with a specific frequency according to the comparison result of comparing the external communication dialing number with the radio gateway code; and

receiving a radio signal input from a radio end, and a transfer system outputting the radio signal as an external communication signal receivable by the external communication end.

In which the radio signal includes an internal code.

In which the radio signal includes a satellite coordinate or an auxiliary signal.

The present invention further provides a radio system which includes a radio communication module and a satellite coordinate receiving module, the radio communication module receives or transmits a radio signal, the satellite coordinate receiving module continuously receives a satellite coordinate, the radio communication module modulates the satellite coordinate into the radio signal which is used as a carrier wave, and the radio communication module receives and demodulates the radio signal having the satellite coordinate to obtain the satellite coordinate.

The system further includes a near-end communication module connected to the radio communication module, the near-end communication module signals an auxiliary message with a local communication end, the radio communication module modulates and outputs the the auxiliary message with the radio signal, receives the radio signal, and obtains the auxiliary message after demodulating the radio signal, where the auxiliary message includes picture, text or video.

The present invention further includes a radio system which includes plural radio ends, a transfer system, and at least one external communication end, the transfer system receives a radio signal broadcasted from the radio ends, transfers the radio signal to a network signal, and outputs the network signal to the external communication end, where the external communication end includes a computer, a mobile communication device, a landline telephone, a web phone, or a webpage.

In which the transfer system receives or transmits the radio signal, in which the radio signal includes a satellite coordinate, and the transfer system modulates or demodulates the radio signal to incorporate or extract the satellite coordinate.

In which the transfer system is a cloud server, and the external communication end communicates with the radio ends via the transfer system through the Internet.

While comparing with existing arts, the feature and benefit of the present invention are as follows:

1. By connecting the server via the radio gateway of the transfer apparatus, the remote radio ends can communicate with a specific external communication end without the limitation of territory or distance.

2. By utilizing the server and the PBX system of the transfer apparatus, the objects that the radio ends are capable of communicating with can be extended to non-radio devices, such as landline telephones, web phones and the like.

3. By pre-registering information in the transfer apparatus, the personnel at the external communication end can be informed of the radio end which transmitted the signal according to the registration data, and thus communicating with specific radio end directly with the identification signal.

4. By utilizing the transfer apparatus, the external communication end can communicate with personnel at plural radio ends.

### BRIEF DESCRIPTION OF THE DRAWINGS

FIG. 1 is a system functional diagram of a preferred embodiment of the present invention;

FIG. 2 is a system functional diagram of a secondarily preferred embodiment of the present embodiment.

### DETAILED DESCRIPTION OF THE PREFERRED EMBODIMENTS

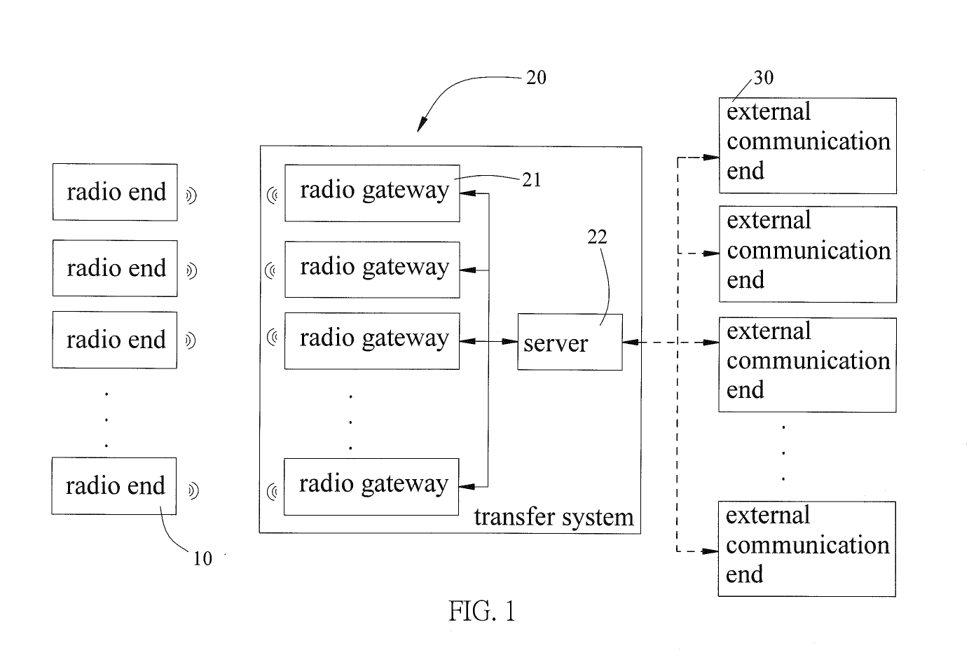

Referring to FIG. 1, a radio communication method is provided by the present invention and includes at least one radio end 10, at least one transfer system 20, and at least one external communication end 30, in which, the radio end (radio receiver/transmitter) 10 is connected with the transfer system 20 via radio signal, and the frequency range where the radio signal commonly operates in includes very high frequency (VHF), ultra high frequency (UHF), high frequency (HF), and so on, where voice communication can be performed between every two radio ends 10 via the aforementioned frequency ranges.

The radio signal of each radio end 10 may also be broadcasted to the transfer system 20 so that each of the transfer systems 20 can communicate with each of the radio ends 10 bi-directionally within a range where the radio signal is transmittable. The transfer system 20 and the external communication end 30 can also signal and perform voice communication with each other via non-radio signals; the connection mode is not limited, which can be a wireless connection, an Internet connection, a wired telephone network connection, etc., such as utilizing wireless cellular networks like 2G, 3G, 4G, a wired or wireless Internet, a landline telephone network, and so on.

The transfer system 20 includes a radio gateway 21 for receiving a radio signal output from the radio end 10, and the transfer system 20 then forwards the radio signal as a network signal. The radio gateway 21 is also capable of receiving and translating external network signals to radio signals to broadcast such radio signals to the radio end 10.

The radio signal can be transmitted via a CTCSS system (Continuous Tone Coded Squelch System); alternatively, when the radio end 10 is a digital radio device, a DCS (Digital-Coded Squelch) system can be utilized in order to include an internal code during transmission of the radio signal. When the radio signal is transmitted via the DSC system, a particular radio end 10 or radio gateway 21 including a corresponding internal code pre-set therein can only receive the radio signal that contains the internal code, and the radio signal including the internal code is output by the radio terminal 10 or the radio gateway 21 which sets the output internal code.

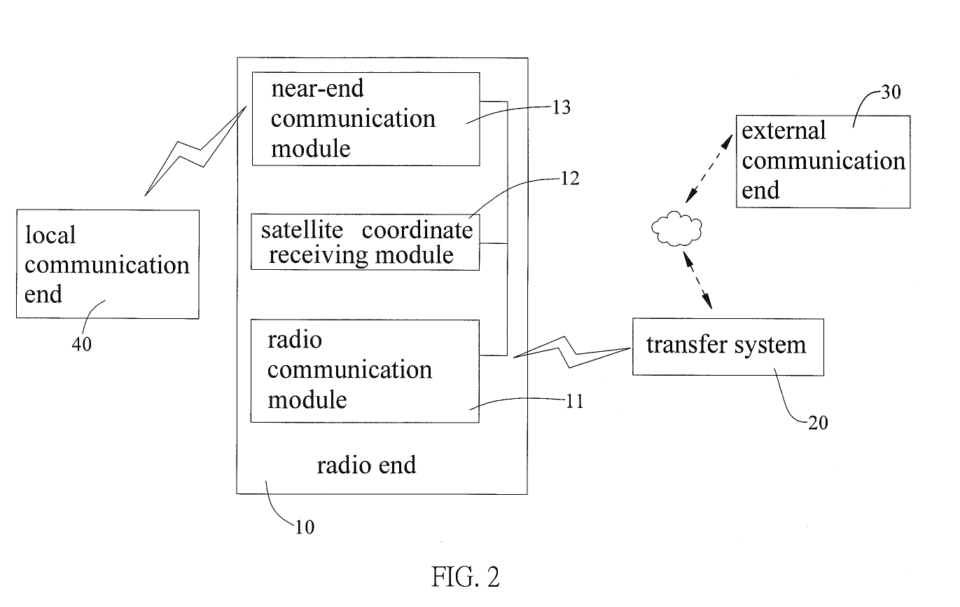

Please refer to FIG. 2, the radio end 10 may include a radio communication module 11 and a satellite coordinate receiving module 12. The radio communication module 11 is electrically connected to the satellite coordinate receiving module 12. The radio communication module 11 communicates with the other radio ends 10 and the transfer systems 20 by the radio signal, the satellite coordinate receiving module 12 continuously receives a satellite coordinate of the radio end 10, and the radio receiving module 11 continuously modulates the satellite coordinates into the radio signal. The radio signal is used as a carrier wave, so that the radio signal having the satellite coordinate can be output to a server 22 or the external communication end 30. In this way, the radio end 10 of the present embodiment can be used for emergency rescue and instant positioning by outputting the satellite coordinates of the radio signal. In addition, the radio communication module 11 may contain demodulation function, so that the radio end 10 can also be demodulated to extract the satellite coordinates.

Further, the radio end 10 may include a near-end communication module 13 connected to the radio communication module 11. The near-end communication module 13 is configured to receive an auxiliary message of a local communication end 40, where such auxiliary messages may be pictures, videos, texts, and so on. After receiving the auxiliary message, the near-end communication module 13 outputs the auxiliary message to the radio communication module 11 so that the auxiliary message is modulated into the radio signal which is used as a carrier wave. In some practical embodiments, the near-end communication module 13 can be a transmission module operating with communication protocols such as Bluetooth or Zigbee. The local communication end 40 may be a mobile device, a mobile phone, a camera and the like. When encountering danger, the mobile device, the phone, or the camera can be used to input an emergency message or to take a picture of the injured site of a user, and such emergency message or picture can be output with the radio signal to other radio ends 10, transfer systems 20 or external communication ends 30. Thus, the radio end 10 of this embodiment can output information that cannot be transmitted by conventional radiophones, which not only helps the user to transmit the geographic location instantly, but also transmits the information required for emergency assistance to reach the best rescue effort.

Further, according to the embodiments of the present invention, the radio gateways 21 can be plural, and these plural radio gateways 21 form plural channels. The number of each channel may be defined as a radio gateway code. The radio signals output from the radio ends 10 may be respectively received by the radio gateways 21 operating in the same radio receiving frequency. Alternatively, the radio signal output from the radio gateway 21 may be received by at least one of the radio ends 10 operating in the same radio receiving frequency.

The transfer system 20 includes a server 22. The server 22 and the radio gateway 21 may be wired or wirelessly connected, such as being connected through physical network signal or wireless network signal. The server 22 receives ii the network signal output from the radio gateway 21, or the other radio gateways 21 receive the network signal output from the server 22.

The server 22 may also be a cloud server. By establishing the server 22 in a cloud system on the Internet, the user can apply for an account and then directly connect to the server 22 via the Internet, so that general communication devices, computers, etc., can be signaling at the radio end 10, and vice versa. As a result, users do not need to set up their own system to perform communication with the radio end 10 via different networks, thereby reducing hardware costs.

The server 22 is connected to a computer, a mobile communication device, a landline telephone or an Internet phone with network signals, and to perform communication between the external communication end 30 and the radio end 10 via applications installed in computers or mobile communication devices. For instance, by dialing out and outputting an external communication signal to the server 22 by and from a communication application of a computer or a mobile communication device to the server 22, the server 22 transmits the external communication signal to the corresponding radio gateway 21 according to a dialing information of the aforementioned communication application, and then the external communication signal is transmitted by the radio gateway 21 with a default radio frequency, and received by the corresponding radio end 10 having the same radio frequency.

Further, the external communication end 30 can be a webpage in a computer or a mobile communication device, which the webpage contains communication function and without installation or download processes, in which the user can access the webpage for communication through an Internet browser. The webpage outputs the external communication signal to the server 22.

The external communication end 30 can be a conventional landline telephone, and the server 22 can be connected with the landline telephone via a PBX (Private Branch Exchange) system. The PBX system can be connected with the server by wire or wirelessly, like connected via physical network signal or wireless network signal. The PBX system receives the network signal output from the server 22, or the server 22 receives the network signal output from the PBX system. The server 22 can be connected with conventional landline telephone devices through the PBX system. Additionally, the PBX system can be connected with the landline telephone devices through a public switched telephone network.

When the external communication end 30 is a landline telephone or mobile phone, a default key of a keyboard of the external communication end 30 can be a dial key to communicate with particular radio end 10. In general, the communication between the radio ends 10 usually broadcasts the radio signals via the dial key provided by the radio ends 10. The external communication end 30 can use physical or virtual keys of the keyboard such as “*”, “# ” or others, as the dial key for communicating with the radio end 10, so that communications between the external communication end 30 and the radio end 10 in no longer limited to distance.

The external communication end 30 can be an Internet phone, and the server 22 can be connected with Internet phones via a VoIP (Voice over Internet Protocol) system.

Each of the external communication ends 30 has to be registered to the server 22 to store a registration data in the server 22. The registration data includes at least one external communication end code and at least one radio dialing number, in which each of the radio dialing number corresponds to one of the external communication end code.

The radio signal output from the radio end 10 includes the radio dialing number, for instance, the radio dialing number is incorporated into the radio signal by using dual tone multi-frequency signals (DTMF). The radio signal is transmitted to the server 22 via the radio gateway 21, the server 22 compares the radio dialing number in the radio signal with the external communication end code, and connects the radio signal with the corresponding external communication end 30.

In which the registration data can be a comparison table, the server 22 connects the radio dialing number with the external communication end code by looking up the comparison table. In which the radio dialing number and the external communication end code can be an identification number, and that the radio end 10 can be connected to the external communication end 30 through comparing the identification codes.

According to the embodiments of the present invention, the radio end 10 can send out the radio dialing number when initiating a call, and after the radio signal is transferred to the server 22 via the radio gateway 21, the server 22 compares the radio dialing number and connects the radio signal to a telephone, a personal computer, or a mobile communication device.

The radio communication method according to an embodiment of the present invention includes the following steps:

Step 1, the radio end 10 transmits radio signal that contains the radio dialing number;

Step 2, the radio gateway 21 transfers the radio signal to the server 22 after receiving it;

Step 3, the server 22 compares the pre-stored registration data with the radio dialing number in the radio signal, and transfers the comparison result to the corresponding external communication end 30.

The radio gateway 21 can be pre-registered in the server 22 in order to store the registration data in the server 22, the registration data includes an external communication dialing number and a radio gateway code, in which each of the external communication dialing number corresponds to one of the radio gateway code.

The external communication signal output from the external communication end 30 includes the external communication dialing number, for instance, the external communication dialing number is incorporated into the external communication signal by using dual tone multi-frequency signals (DTMF). While the external communication signal has been transmitted to the server 22, the server 22 compares the external communication dialing number in the external communication signal with the radio gateway code, and then connects the external communication signal with the corresponding radio gateway 21. The radio gateway 21 transmits the radio signal to be received by the radio end 10 operating in the same radio frequency. In which, the radio gateway code can be displayed on the communication device at the external communication end 30, so as to inform the user at the external communication end 30 the radio gateway 21 the user is communicating with.

According to an embodiment of the present invention, the external communication end 30 can be a landline telephone, a personal computer or a mobile communication device. The external communication end 30 transmits the external communication dialing number at the time a call is initiated, after the external communication signal is transmitted to the server 22, the server 22 connects the external communication signal with the corresponding radio gateway 21 according to the external communication dialing number.

The external communication-end radio communication method according to an embodiment of the present invention includes the following steps:

Step 1, the external communication end 30 transmits external communication signal which contains the external communication dialing number;

Step 2, the server 22 compares the pre-stored registration data according to the external communication dialing number, and transfers to the corresponding radio gateway 21 according to the comparison result;

Step 3, the corresponding radio gateway 21 outputs radio signal, and the radio end 10 operating in the same radio frequency receives the radio signal.

In which the radio end 10 that is used to receive radio signal can be plural, the radio ends 10 can receive the radio signal as long as the radio ends operate in the same radio frequency, so that a single external communication end 30 can be broadcasting to plural radio ends 10 at once.

In practice, the radio ends 10 can be deployed at different locations, as long as a set of the radio gateway 21 is set within a range in which the radio signals can be effectively transmitted. Each of the radio gateways 21 is connected to the server 22 and the external communication ends 30 via the Internet. For example, the radio ends 10 can be carried by staffs located at different floors, and the external communication end 30 can be a command unit. By practicing the radio communication method of the present invention, the staffs scattered everywhere can communicate with the same location without being limited by the effective communication distance of the radio signals, and the external communication end 30 can communicate with the specific radio gateway 21 through the radio gateway code, and the radio gateway 21 that receives the external communication signal outputs radio signal with a specific frequency to be received by the radio ends 10 that operates in the same receiving frequency.

Further, the radio ends 10 that are set with different transceiving radio frequencies can be communicating with each other laterally via the server 22. Additionally, the radio ends 10 located farther than the effective communication distance of the radio signals can communicate with each other as well through the server 22.

It can be concluded from the above that the present invention has the following advantages:

1. By connecting the server 22 via the radio gateways 21 of the transfer apparatus, the remote radio ends 10 can communicate with a specific external communication end 30 without the limitation of territory or distance.

2. By utilizing the server 22 and the PBX system of the transfer apparatus, the objects that the radio ends 10 are capable of communicating with can be extended to non-radio devices, such as landline telephones, web phones and the like.

3. By pre-registering information in the transfer apparatus, the personnel at the external communication end 30 can be informed of the radio end 10 which ii transmitted the signal according to the registration data, and thus communicating with specific radio end 10 directly with the identification signal.

4. By utilizing the transfer apparatus, the external communication end 30 can communicate with personnel at plural radio ends 10.

5. The radio signal can include satellite coordinate, picture, text, or video, and that resolving the limitation of conventional radio phones.

The foregoing is merely preferred embodiments of the present invention and is not intended to limit the present invention. For those skilled in the art, the present invention may have various modifications and changes. Any modification, equivalent replacement, improvement, etc. within the spirit and principle of the present invention should be included in the scope of the present invention.

1. A radio-end radio communication method, characterized in that the method comprises the steps of:
receiving a radio signal output from a radio end;
comparing a radio dialing number in the radio signal with a registration data, wherein the registration data includes at least one external communication end code and at least one radio dialing number, and each of the radio dialing numbers corresponds to an external communication end code;
transferring the radio signal to a corresponding external communication end according to a comparison result of comparing the radio dialing number with the external communication end code; and
receiving an external communication signal input from the external communication end.

2. The radio-end radio communication method as claimed in claim 1, characterized in that the radio dialing number is incorporated in the radio signal by utilizing dual-tone multi-frequency codes.

3. The radio-end radio communication method as claimed in claim 2, characterized in that the radio signal includes an internal code.

4. The radio-end radio communication method as claimed in claim 3, characterized in that the radio signal includes a satellite coordinate or an auxiliary signal.

5. An external communication-end radio communication method, characterized in that the method comprises the steps of:
receiving an external communication signal having an external communication dialing number transmitted from at least one external communication end;
comparing the external communication dialing number of the external communication signal with an internally stored registration data, wherein the registration data includes at least one external communication dialing number and at least one radio gateway code, and each of the at least one external communication dialing number corresponds to one of the at least one radio gateway code, and outputting a radio signal with a specific frequency according to the comparison result of comparing the external communication dialing number with the radio gateway code; and
receiving a radio signal input from a radio end, and a transfer system outputting the radio signal as an external communication signal receivable by the external communication end.

6. The external communication-end radio communication method as claimed in claim 5, characterized in that the radio signal includes an internal code.

7. The external communication-end radio communication method as claimed in claim 6, characterized in that the radio signal includes a satellite coordinate or an auxiliary signal.

8. A radio system, characterized in that the system comprises a radio communication module and a satellite coordinate receiving module, the radio communication module receiving or transmitting a radio signal, the satellite coordinate receiving module continuously receiving a satellite coordinate, the radio communication module modulates the satellite coordinate into the radio signal used as a carrier wave, and the radio communication module receiving and demodulating the radio signal having the satellite coordinate to obtain the satellite coordinate.

9. The radio system as claimed in claim 8, characterized in that the system comprises a near-end communication module connected to the radio communication module, wherein the near-end communication module signals an auxiliary message with a local communication end, the radio communication module modulates the auxiliary message to the radio signal and outputs the radio signal, receives the radio signal, and obtains the auxiliary message after demodulating the radio signal, wherein the auxiliary message includes picture, text or video.

10. A radio system, characterized in that the system comprises a plurality of radio ends, a transfer system, and at least one external communication end, wherein the transfer system receives a radio signal broadcasted by the radio ends, transfers the radio signal to a network signal, and outputs the network signal to the external communication end, wherein the external communication end includes a computer, a mobile communication device, a landline telephone, a web phone, or a webpage.

11. The radio system as claimed in claim 10, characterized in that the transfer system receives or transmits the radio signal, wherein the radio signal includes a satellite coordinate, and the transfer system modulates or demodulates the radio signal to incorporate or extract the satellite coordinate.

12. The radio system as claimed in claim 11, characterized in that the transfer system is a cloud server, and the external communication end communicates with the radio ends via the transfer system through the Internet.

13. The radio system as claimed in claim 10, characterized in that the transfer system is a cloud server, and the external communication end communicates with the radio ends via the transfer system through the Internet.

14. The radio-end radio communication method as claimed in claim 1, characterized in that the radio signal includes an internal code.

15. The radio-end radio communication method as claimed in claim 14, characterized in that the radio signal includes a satellite coordinate or an auxiliary signal.

16. The external communication-end radio communication method as claimed in claim 5, characterized in that the radio signal includes a satellite coordinate or an auxiliary signal.
